(19) United States
(12) Patent Application Publication
(10) Pub. No.: US 2007/0038900 A1
(43) Pub. Date: Feb. 15, 2007

(54) System with executing nodes for executing schedules

(75) Inventors: Andrey Kisel, Berkshire (GB); Steve P. Molloy, Bristol (GB)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/500,983

(22) Filed: Aug. 9, 2006

(30) Foreign Application Priority Data
Aug. 10, 2005 (EP) 05291707.7

(51) Int. Cl. G06F 11/00

(52) U.S. Cl. 714/49

(57) ABSTRACT

In a system (1) with storing means (2) for storing schedules (200, 210, 220, 230) and comprising nodes (3-6) for executing the schedules (200, 210, 220, 230), first and second nodes (3, 4) are primary and secondary nodes and comprise checking means (302, 402) for checking the storing means (2) and collecting means (303, 403) for collecting schedules on the node's own initiative. This all is done without the nodes (3, 4) being monitored by a monitoring process of a system supervisor. The different kinds of nodes create a node hierarchy. At least one so-called single point of failure in the form of a monitoring process has been removed. Marking means (304, 404) mark the schedules in the storing means (2). The nodes (3, 4) comprise event driven scheduler (300, 400) for controlling the means (302-304, 402-404). The checking means (302) of the primary node check the storing means (2) a first predefined time-interval ahead of an actual schedule and the checking means (402) of the secondary node check the storing means (2) a second predefined time-interval ahead of an actual schedule, the first predefined time-interval being larger than the second predefined time-interval, to make the primary nodes more privileged than the secondary nodes.

The invention relates to a system comprising storing means for storing schedules and comprising executing nodes for executing the schedules.

A node may for example be a server node forming part of a system in the form of a server or may for example be a network node forming part of a system in the form of a network.

A prior art system is known from US 2003/0172212 A1, which discloses a round robin arbitration system. As disclosed in paragraph 0005 of US 2003/0172212 A1, round robin arbitration is defined by sequential, cyclical allocation of resources to numerous requesters.

The known system is disadvantageous, inter alia, owing to the fact that round robin arbitration requires the nodes to be monitored by a monitoring process. Such a monitoring process makes the system relatively complex. Further, the monitoring process forms a so-called single point of failure. In case the monitoring process fails, the whole system fails.

It is an object of the invention, inter alia, to provide a system as defined above that is relatively simple.

The system according to the invention is characterized in that the executing nodes comprise a first executing node and a second executing node, the first executing node being a primary node and comprising first checking means for checking the storing means and first collecting means for collecting first schedules on the first executing node's own initiative and the second executing node being a secondary node and comprising second checking means for checking the storing means and second collecting means for collecting second schedules on the second executing node's own initiative.

By introducing, per node, the checking means for checking the storing means on the executing node's own initiative and the collecting means for collecting the schedules on the executing node's own initiative, all without the executing node being monitored by a monitoring process of a system supervisor, the system according to the invention has become relatively simple. By introducing at least two different kinds of nodes, primary nodes and secondary nodes, a node hierarchy has been created, to avoid arbitration.

The system according to the invention is further advantageous, inter alia, in that at least one so-called single point of failure has been removed (the monitoring process). This makes the system according to the invention more reliable.

An embodiment of the system according to the invention is characterized in that the first executing node comprises first marking means for marking the first schedules in the storing means and the second executing node comprises second marking means for marking the second schedules in the storing means.

The first marking means of the primary node for example mark a first schedule as “being executed” in case the first collecting means of the primary node want to collect or are collecting or have collected this first schedule. As a result, the second checking means of the secondary node will, while checking the storing means, ignore or overlook or not even find this first schedule.

An embodiment of the system according to the invention is characterized in that the first executing node comprises a first event driven scheduler for controlling the first means and in that the second executing node comprises a second event driven scheduler for controlling the second means.

The schedulers are event driven or schedule driven and control the means. These means may form part of the schedulers or not.

An embodiment of the system according to the invention is characterized in that the executing nodes compete for executing the schedules, the primary node being more privileged than the secondary node.

Without the executing nodes being monitored by a monitoring process of a system supervisor, the executing nodes will be in competition with each other. The fact that primary nodes are more privileged than secondary nodes is one way to avoid arbitration. Other ways to avoid arbitration are not to be excluded.

An embodiment of the system according to the invention is characterized in that the first checking means check the storing means a first predefined time-interval ahead of an actual schedule and the second checking means check the storing means a second predefined time-interval ahead of an actual schedule, the first predefined time-interval being larger than the second predefined time-interval.

The fact that the different checking means check the storing means different predefined time-intervals ahead of the actual schedule is one way to make the primary nodes more privileged than the secondary nodes. Other ways to make the primary nodes more privileged than the secondary nodes are not to be excluded.

An embodiment of the system according to the invention is characterized in that the schedules are defined by time information and type information.

The time information defines for example when the schedule is to be executed and the type information defines for example to which category the schedule belongs.

An embodiment of the system according to the invention is characterized in that the time information comprises a start time and a stop time and in that the type information defines a type and a destination.

The destination may be in the form of an internet protocol address, without excluding other addresses such as medium access control addresses and uniform resource locators. The type for example defines a broadcast or a content distribution or a content delivery.

An embodiment of the system according to the invention is characterized in that the executing nodes form a cluster of nodes, the primary node usually delivering services and the secondary node only delivering services after a loss of the primary node.

The secondary node is for example a stand-by node which is waiting for the primary node to go down and for replacing this primary node after the primary node has gone down.

An embodiment of the system according to the invention is characterized in that the system comprises an internet protocol television broadcast system.

Especially but not exclusively for internet protocol television broadcast system it will be a great advantage to use the competing and executing nodes which are not monitored by a monitoring process of a system supervisor.

An embodiment of the system according to the invention is characterized in that the system comprises a server system wherein the nodes are server nodes or comprises a network system wherein the nodes are network nodes.

The server nodes may be in the same housing as the server storing means or not. The network nodes will usually each have their own housing. The network storing means may be in the same housing as one of the network nodes or not and then have their own housing.

The invention also relates to a first executing node for use in a system comprising storing means for storing schedules and comprising executing nodes for executing the schedules, which first executing node according to the invention is characterized in that the executing nodes comprise the first executing node and a second executing node, the first executing node being a primary node and comprising first checking means for checking the storing means and first collecting means for collecting first schedules on the first executing node's own initiative and the second executing node being a secondary node and comprising second checking means for checking the storing means and second collecting means for collecting second schedules on the second executing node's own initiative.

The invention also relates to a second executing node for use in a system comprising storing means for storing schedules and comprising executing nodes for executing the schedules, which second executing node according to the invention is characterized in that the executing nodes comprise a first executing node and the second executing node, the first executing node being a primary node and comprising first checking means for checking the storing means and first collecting means for collecting first schedules on the first executing node's own initiative and the second executing node being a secondary node and comprising second checking means for checking the storing means and second collecting means for collecting second schedules on the second executing node's own initiative.

The invention also relates to a method for executing schedules, which method according to the invention is characterized in that the method comprises the steps of checking storing means and collecting first schedules on an own initiative of a first executing node and of checking the storing means and collecting second schedules on an own initiative of a second executing node.

The invention also relates to a computer program product for executing schedules, which computer program product according to the invention is characterized in that the computer program product comprises the functions of checking storing means and collecting first schedules on an own initiative of a first executing node and of checking the storing means and collecting second schedules on an own initiative of a second executing node.

The invention also relates to a medium for storing the computer program product according to the invention.

Embodiments of the first executing node according to the invention and of the second executing node according to the invention and of the method according to the invention and of the computer program product according to the invention and of the medium according to the invention correspond with the embodiments of the system according to the invention.

The invention is based upon an insight, inter alia, that a monitoring process forms a so-called single point of failure, and is based upon a basic idea, inter alia, that the monitoring process can be avoided by letting the executing nodes check and collect on their own initiative and without being monitored by a monitoring process of a system supervisor.

The invention solves the problem, inter alia, to provide a system that is relatively simple. The system according to the invention is further advantageous, inter alia, in that at least one so-called single point of failure has been removed (the monitoring process). This makes the system according to the invention more reliable.

These and other aspects of the invention will be apparent from and elucidated with reference to the embodiments(s) described hereinafter.

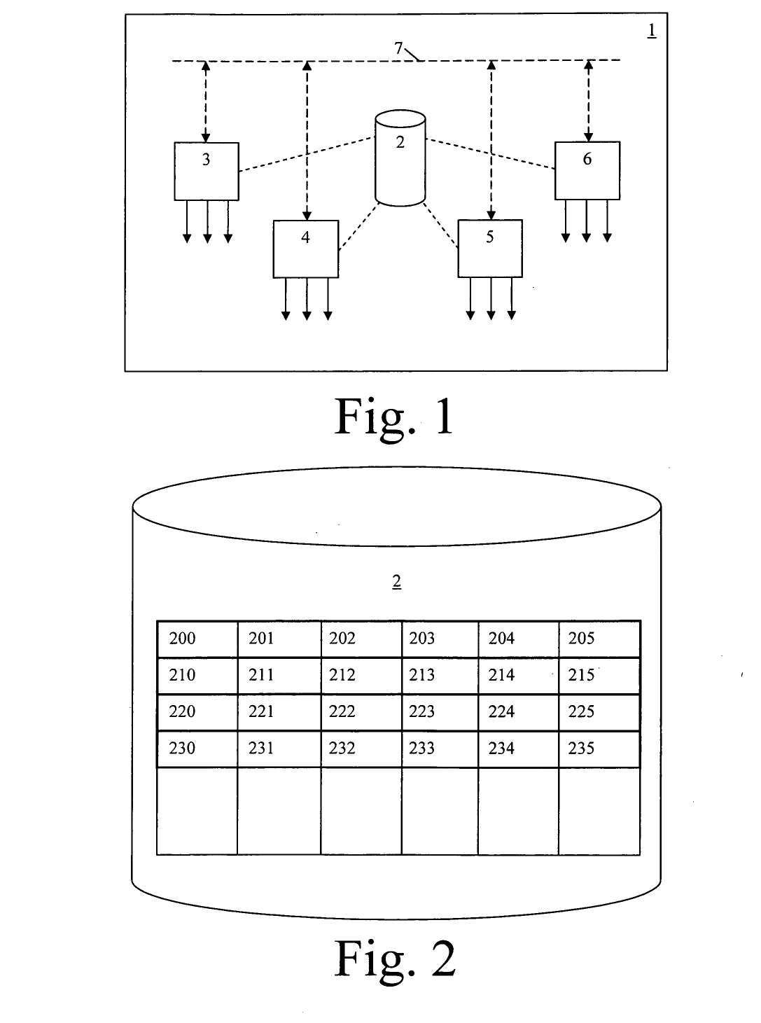

FIG. 1 shows diagrammatically a system according to the invention comprising storing means and executing nodes according to the invention,

FIG. 2 shows diagrammatically in greater detail storing means for use in a system according to the invention, and

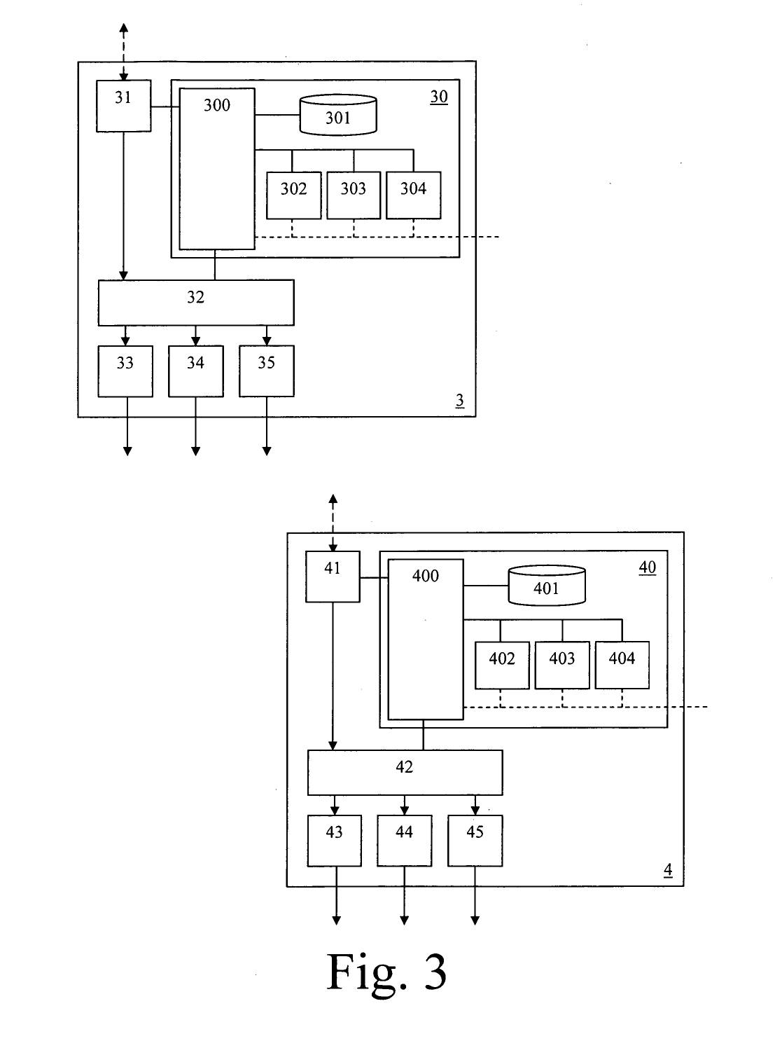

FIG. 3 shows diagrammatically in greater detail a first executing node according to the invention and a second executing node according to the invention.

The system 1 according to the invention shown in FIG. 1 comprises four executing nodes 3-6. A receiving side of each executing node 3-6 is coupled to a supplier 7 and a transmitting side of each executing node 3-6 is coupled to further (executing or non-executing) nodes not shown. A control side of each executing node 3-6 is coupled to storing means 2 which are shown in FIG. 2 in greater detail. The system 1 may comprise a server system wherein the executing nodes 3-6 are server nodes or may comprise a network system wherein the executing nodes 3-6 are network nodes. The server nodes may be in the same housing as the server storing means or not. The network nodes will usually each have their own housing. The network storing means may be in the same housing as one of the network nodes or not and then have their own housing.

The storing means 2 shown in FIG. 2 comprise for example a table memory with rows and columns. Each row for example comprises one schedule defined by a start information and type information to be found in different columns. For example a schedule 200 is defined by a start time 201, a stop time 202, a type 203 and a destination 204. For example a schedule 210 is defined by a start time 211, a stop time 212, a type 203 and a destination 204 etc.

The first executing node 3 shown in FIG. 3 comprises a controller 30 coupled to a supplier interface 31, to a switch 32 and to node interfaces 33-35. The supplier interface 31 is further coupled to the supplier 7 shown in FIG. 1 and to the switch 32. The node interfaces 33-35 are further coupled to the switch 32 and to the further nodes not shown. The controller 30 for example comprises a first (hardware and/or software) scheduler 300 coupled to a memory 301, to first (hardware and/or software) checking means 302 for checking the storing means 2 and to first (hardware and/or software) collecting means 303 for collecting first schedules on the first executing node's own initiative from the storing means 2 and to first (hardware and/or software) marking means 304 for marking the first schedules in the storing means 2. These means 302-304 are thereto further coupled to the storing means 2.

The second executing node 4 shown in FIG. 3 comprises a controller 40 coupled to a supplier interface 41, to a switch 42 and to node interfaces 43-45. The supplier interface 41 is further coupled to the supplier 7 shown in FIG. 1 and to the switch 42. The node interfaces 43-45 are further coupled to the switch 42 and to the further nodes not shown. The controller 40 for example comprises a second (hardware and/or software) scheduler 400 coupled to a memory 401, to second (hardware and/or software) checking means 402 for checking the storing means 2 and to second (hardware and/or software) collecting means 403 for collecting second schedules on the second executing node's own initiative from the storing means 2 and to second (hardware and/or software) marking means 404 for marking the second schedules in the storing means 2. These means 402-404 are thereto further coupled to the storing means 2.

In a prior art situation, somewhere in the system 1, for example inside or near the storing means 2, there is a monitoring process for monitoring the nodes 3-6 for allocating the schedules 200, 210, 220, 230 stored in the storing means 2 to the different nodes 3-6 (one schedule can only be allocated to one node at a time). Such a monitoring process forms for example part of a system supervisor or is controlled by such a system supervisor. This monitoring process forms a so-called single point of failure. In case the monitoring process fails, the whole system fails. The monitoring process further increases a complexity of the system 1.

To avoid such a monitoring process, in the system 1 according to the invention, the first executing node 3 is defined to be a primary node that comprises the first checking means 302 for checking the storing means 2 and the first collecting means 303 for collecting first schedules on the first executing node's own initiative, and the second executing node 4 is defined to be a secondary node that comprises the second checking means 402 for checking the storing means 2 and the second collecting means 403 for collecting second schedules on the second executing node's own initiative. The introduction of at least two different kinds of nodes, primary nodes and secondary nodes, results in a node hierarchy being created, to avoid prior art arbitration. Further, at least one so-called single point of failure has been removed by having removed the monitoring process. This increases the reliability of the system 1 according to the invention.

So, compared to a prior art situation, the executing nodes 3, 4 are no longer monitored by a system supervisor and are no longer instructed what to do. Contrary to that, the executing nodes 3, 4 check the storing means 2 on their own initiative and independently from each other, and collect the schedules 200, 210, 220, 230 under two conditions. Firstly, a schedule 200, 210, 220, 230 must still be available to be collected by an executing node 3, 4, and secondly, the executing node 3, 4 must be willing and prepared and capable to collect the schedule 200, 210, 220, 230.

To be sure that a schedule is still available to be collected by an executing node 3, 4 and to avoid that two executing nodes 3, 4 collide when checking and/or collecting schedules 200, 210, 220, 230, internal or external clocks of the executing nodes 3, 4 could be synchronized such that the checking and/or the collecting by the executing nodes 3, 4 are separated in time from each other and more than is strictly necessary. This however is a relatively inefficient solution.

According to a more efficient solution, the first executing node 3 comprises the first marking means 303 for marking the first schedules in the storing means 2 and the second executing node 4 comprises the second marking means 403 for marking the second schedules in the storing means 2. The first marking means 303 of the primary node for example mark a first schedule as “being executed” in case the first collecting means 302 of the primary node want to collect or are collecting or have collected this first schedule. As a result, the second checking means 402 of the secondary node will, while checking the storing means 2, ignore or overlook or not even find this first schedule. Thereto, in the storing means 2, the schedules 200, 210, 220, 230 for example comprise the marks 205, 215, 225, 235.

The first scheduler 300 for example comprises a first event driven scheduler for controlling the memory 301 and the first means 302-304 and the second scheduler 400 for example comprises a second event driven scheduler for controlling the memory 401 and the second means 402-404. Alternatively, the first and second means 302-304, 402-404 may form part of the first and second schedulers.

Without the executing nodes 3, 4 being monitored by a monitoring process of a system supervisor, the executing nodes 3, 4 will be in competition with each other. So, the executing nodes 3, 4 compete for executing the schedules, with the primary node being more privileged than the secondary node. Thereto, each executing node 3, 4 may get a (different) priority indicator for solving collisions between the checking and/or collecting executing nodes 3, 4. This however is a relatively non-elegant solution.

According to a relatively elegant solution, the first checking means 302 check the storing means 2 a first predefined time-interval ahead of an actual schedule and the second checking means 402 check the storing means 2 a second predefined time-interval ahead of an actual schedule, the first predefined time-interval being larger than the second predefined time-interval. This way, the primary node checks for example a time-interval T ahead of an actual schedule (or an actual time), the secondary node checks for example a time-interval T−Δt ahead of an actual schedule (or an actual time), a tertiary node checks for example a time-interval T−2 Δt ahead of an actual schedule (or an actual time) etc. An Nth node checks for example a time-interval T−(N−1) Δt ahead of an actual schedule (or an actual time), whereby (N−1) Δt<T. As a result, the primary node has the primary choice and the secondary node has the secondary choice and the tertiary node has the tertiary choice etc.

The schedules 200, 210, 220, 230 are defined by time information 201, 202, 211, 212, 221, 222, 231, 232 and type information 203, 204, 213, 214, 223, 224, 233, 234. The time information 201, 202, 211, 212, 221, 222, 231, 232 comprises a start time 201, 211, 221, 231 and a stop time 202, 212, 222, 232 and the type information 203, 204, 213, 214, 223, 224, 233, 234 defines a type 203, 213, 223, 233 and a destination 204, 214, 224, 234.

The destination 204, 214, 224, 234 may be in the form of an internet protocol address, without excluding other addresses such as medium access control addresses and uniform resource locators. The type 203, 213, 223, 233 for example defines a broadcast or a content distribution or a content delivery.

The executing nodes 3-6 may form a cluster of nodes, whereby the primary node usually delivers services and the secondary node only delivers services after a loss of the primary node. The secondary node is for example a stand-by node which is waiting for the primary node to go down and for replacing this primary node after the primary node has gone down. The tertiary node for example only delivers services after a loss of the secondary node. The tertiary node is for example a stand-by node which is waiting for the secondary node to go down and for replacing this secondary node after the secondary node has gone down.

Alternatively, several of the executing nodes 3-6 may be primary nodes and several of the other executing nodes 3-6 may be secondary nodes etc.

Especially but not exclusively for internet protocol television broadcast system it will be a great advantage to use the competing and executing nodes 3-6 which are not monitored by a monitoring process of a system supervisor. For such an internet protocol television broadcast system, a schedule 200 for example defines that at a start time 20h00 until a stop time 22h00 a content delivery A is to be delivered to a destination B, and a schedule 210 for example defines that at a start time 23h00 until a stop time 24h00 a content delivery C is to be delivered to a destination D. Then, the primary node that for example checks the storing means ten hours in advance will find at 10h00 the schedule 200 and will mark it as being executed and will find at 13h00 the schedule 210 and will mark it as being executed. Then, for example shortly before 20h00, the primary node will collect and/or receive the entire content delivery A or at least a part of the content delivery A from the supplier and will start passing this entire content delivery or this part of the content delivery to the destination B etc. and, for example shortly before 23h00, the primary node will collect and/or receive the entire content delivery C or at least a part of the content delivery C from the supplier and will start passing this entire content delivery or this part of the content delivery to the destination D etc.

In case the primary node cannot handle both content deliveries A and C that shortly after each other, the primary node will not mark the schedule 210 as being executed, and the secondary node that for example checks the storing means six hours in advance will find at 17h00 the schedule 210 and will mark it as being executed. Then, for example shortly before 23h00, the secondary node will collect and/or receive the entire content delivery C or at least a part of the content delivery C from the supplier and will start passing this entire content delivery or this part of the content delivery to the destination D etc.

In case the primary node goes down at 12h00, the schedule 200 has already been marked by the primary node but the schedule 210 has not yet been marked. The secondary node that for example checks the storing means six hours in advance will find at 17h00 the schedule 210 and will mark it as being executed etc. For the schedule 200, two options exist. According to a first option, in case the storing means are informed of the primary node having gone down, the storing means might delete the mark introduced by the primary node and as a result the secondary node that for example checks the storing means six hours in advance will find at 14h00 the schedule 200 and will mark it as being executed etc. According to a second option, in case the storing means are not informed of the primary node having gone down, the schedule 200 will be lost.

The invention has the following advantages over prior art solutions. Firstly, resilient internet protocol television broadcasts and content distribution services are implemented in a distributed content delivery/video server network without the mentioned single point of failure being present. Secondly, the need for monitoring processes and their associated overhead has been removed. Thirdly, a loss of N−1 executing nodes is tolerated. Fourthly, it can be implemented on low cost general purpose computers because it does not rely on high availability monitoring processes. And fifthly, it can easily scale up and down because there is no inter-node communication involved.

In FIGS. 1 and 3, each coupling/connection may be a wired coupling/connection or a wireless coupling/connection. Any unit shown may be divided into sub-units, and any two or more units may be integrated into a new and larger unit. Any unit shown may comprise hardware and/or software. The computer program product according to the invention for executing schedules 200, 210, 220, 230 may be stored on a fixed medium such as the memory 301, 401 or on a removable medium not shown. A particular incarnation of the storing means might be a memory or a database, but other incarnations can be used for storing schedules as well, if they are accessible by the execution nodes for checking for new schedules either directly or indirectly via proxy solutions.

The expression “for” in for example “for storing” etc. does not exclude that other functions are performed as well, simultaneously or not. The expressions “X coupled to Y” and “a coupling between X and Y” and “coupling/couples X and Y” etc. do not exclude that an element Z is in between X and Y. The expressions “P comprises Q” and “P comprising Q” etc. do not exclude that an element R is comprised/included as well. The terms “a” and “an” do not exclude the possible presence of one or more pluralities. The word “means” may comprise a single means or a single unit or a plurality of means or a plurality of units.

The steps and/or functions of checking and collecting do not exclude further steps and/or functions, like for example, inter alia, the steps and/or functions described for the Figures etc. Between each pair of blocks shown in the Figures, a further block not shown may be present, and in addition to a block shown in the Figures, a further block not shown and coupled to this block shown may be present etc.

1. System (1) comprising storing means (2) for storing schedules (200, 210, 220, 230) and comprising executing nodes (3, 4, 5, 6) for executing the schedules (200, 210, 220, 230), characterized in that the executing nodes (3, 4, 5, 6) comprise a first executing node (3) and a second executing node (4), the first executing node (3) being a primary node and comprising first checking means (302) for checking the storing means (2) and first collecting means (303) for collecting first schedules on the first executing node's own initiative and the second executing node (4) being a secondary node and comprising second checking means (402) for checking the storing means (2) and second collecting means (403) for collecting second schedules on the second executing node's own initiative.

2. System (1) as defined in claim 1, characterized in that the first executing node (3) comprises first marking means (304) for marking the first schedules in the storing means (2) and the second executing node (4) comprises second marking means (404) for marking the second schedules in the storing means (2).

3. System (1) as defined in claim 1, characterized in that the first executing node (3) comprises a first event driven scheduler (300) for controlling the first means (302-304) and in that the second executing node (4) comprises a second event driven scheduler (400) for controlling the second means (402-404).

4. System (1) as defined in claim 1, characterized in that the executing nodes (3, 4, 5, 6) compete for executing the schedules (200, 210, 220, 230), the primary node being more privileged than the secondary node.

5. System (1) as defined in claim 1, characterized in that the first checking means (302) check the storing means (2) a first predefined time-interval ahead of an actual schedule and the second checking means (402) check the storing means (2) a second predefined time-interval ahead of an actual schedule, the first predefined time-interval being larger than the second predefined time-interval.

6. System (1) as defined in claim 1, characterized in that the schedules (200, 210, 220, 230) are defined by time information (201, 202, 211, 212, 221, 222, 231, 232) and type information (203, 204, 213, 214, 223, 224, 233, 234).

7. System (1) as defined in claim 6, characterized in that the time information (201, 202, 211, 212, 221, 222, 231, 232) comprises a start time (201, 211, 221, 231) and a stop time (202, 212, 222, 232) and in that the type information (203, 204, 213, 214, 223, 224, 233, 234) defines a type (203, 213, 223, 233) and a destination (204, 214, 224, 234).

8. System (1) as defined in claim 1 characterized in that the executing nodes (3, 4, 5, 6) form a cluster of nodes, the primary node usually delivering services and the secondary node only delivering services after a loss of the primary node.

9. System (1) as defined in claim 1 characterized in that the system (1) comprises an internet protocol television broadcast system.

10. System (1) as defined in claim 1, characterized in that the system (1) comprises a server system wherein the executing nodes (3, 4, 5, 6) are server nodes or comprises a network system wherein the executing nodes (3, 4, 5, 6) are network nodes.

11. First executing node (3) for use in a system (1) comprising storing means (2) for storing schedules (200, 210, 220, 230) and comprising executing nodes (3, 4, 5, 6) for executing the schedules (200, 210, 220, 230), characterized in that the executing nodes (3, 4, 5, 6) comprise the first executing node (3) and a second executing node (4), the first executing node (3) being a primary node and comprising first checking means (302) for checking the storing means (2) and first collecting means (303) for collecting first schedules on the first executing node's own initiative and the second executing node (4) being a secondary node and comprising second checking means (402) for checking the storing means (2) and second collecting means (403) for collecting second schedules on the second executing node's own initiative.

12. Second executing node (4) for use in a system (1) comprising storing means (2) for storing schedules (200, 210, 220, 230) and comprising executing nodes (3, 4, 5, 6) for executing the schedules (200, 210, 220, 230), characterized in that the executing nodes (3, 4, 5, 6) comprise a first executing node (3) and the second executing node (4), the first executing node (3) being a primary node and comprising first checking means (302) for checking the storing means (2) and first collecting means (303) for collecting first schedules on the first executing node's own initiative and the second executing node (4) being a secondary node and comprising second checking means (402) for checking the storing means (2) and second collecting means (403) for collecting second schedules on the second executing node's own initiative.

13. Method for executing schedules (200, 210, 220, 230), characterized in that the method comprises the steps of checking storing means (2) and collecting first schedules on an own initiative of a first executing node (3) and of checking the storing means (2) and collecting second schedules on an own initiative of a second executing node (4).

14. Computer program product for executing schedules (200, 210, 220, 230), characterized in that the computer program product comprises the functions of checking storing means (2) and collecting first schedules on an own initiative of a first executing node (3) and of checking the storing means (2) and collecting second schedules on an own initiative of a second executing node (4).

15. Medium (301, 401) for storing the computer program product as defined in claim 14.
